(19) United States
(12) Patent Application Publication
(10) Pub. No.: US 2026/0303529 A1
(43) Pub. Date: Oct. 1, 2026

(54) PACKET DISTRIBUTION IN A MULTI-TILE PROCESSING SYSTEM

(71) Applicant: Fujitsu Limited, Kawasaki-shi (JP)

(72) Inventor: Ian ELMOR LANG, Toronto (CA)

(73) Assignee: Fujitsu Limited, Kawasaki-shi (JP)

(21) Appl. No.: 19/094,560

(22) Filed: Mar. 28, 2025

(51) Int. Cl. H04L 47/12; H04L 47/10

(52) U.S. Cl. CPC H04L 47/12; H04L 47/29

(57) ABSTRACT

A method of packet distribution in a multi-tile processing system may include receiving, at a first tile of a multi-tile processing system, a first packet from a second tile of the multi-tile processing system. The first packet may include network congestion data indicating network congestion of one or more tiles of the multi-tile processing system in a network path between the first tile and the second tile. The method may further include selecting, by the first tile based on the network congestion data, a packet distribution method for sending a second packet from the first tile to the second tile.

### FIELD

The present disclosure generally relates to packet distribution in a multi-tile processing system.

### BACKGROUND

Devices today may use multi-tile processing systems. Multi-tile processing systems may leverage multiple interconnected processing tiles to enhance computational efficiency, scalability, and/or power efficiency. Each processing tile may include a processor core, memory, and interconnect components, enabling parallel execution of tasks and optimized workload distribution. Multi-tile processing systems may be employed in high-performance computing, artificial intelligence, and data-intensive applications, where the ability to process tasks concurrently improves throughput and reduces latency. By utilizing advanced interconnect architectures, such as mesh or network-on-chip (NoC) designs, multi-tile processing systems facilitate efficient data exchange between tiles.

The subject matter claimed in the present disclosure is not limited to embodiments that solve any disadvantages or that operate only in environments such as those described above. Rather, this background is only provided to illustrate example technology areas where some embodiments described in the present disclosure may be practiced.

### SUMMARY

A method of packet distribution in a multi-tile processing system may include receiving, at a first tile of a multi-tile processing system, a first packet from a second tile of the multi-tile processing system. The first packet may include network congestion data indicating network congestion of one or more tiles of the multi-tile processing system in a network path between the first tile and the second tile. The method may further include selecting, by the first tile based on the network congestion data, a packet distribution method for sending a second packet from the first tile to the second tile.

The objects and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1A illustrates an example multi-tile processing system;

FIG. 1B illustrates an example tile of a multi-tile processing system;

FIG. 2A illustrates an example transmission of a first packet in a multi-tile processing system;

FIG. 2B illustrates an example transmission of a second packet in a multi-tile processing system;

FIG. 2C illustrates an example transmission of third packets in a multi-tile processing system;

FIG. 2D illustrates an example transmission of fourth packets in a multi-tile processing system;

FIG. 3A illustrates reception of a packet by a tile;

FIG. 3B illustrates processing of a packet by a tile;

FIG. 3C illustrates transmission of a packet by a tile;

FIG. 4 illustrates an example packet;

FIG. 5A illustrates an example transmission of first packets in an example multi-tile processing system without congestion;

FIG. 5B illustrates an example transmission of first packets in an example multi-tile processing system with congestion;

FIG. 6 illustrates a flowchart of an example method of packet distribution in a multi-tile processing system;

FIG. 7A illustrates example bit masks;

FIG. 7B illustrates another example bit mask;

FIG. 7C illustrates another example bit mask; and

FIG. 8 illustrates a flowchart of another example method of packet distribution in a multi-tile processing system, all in accordance with one or more embodiments of the present disclosure.

### DETAILED DESCRIPTION

Multi-tile processing systems may include multiple processing tiles interconnected by a network. Each tile may include one or more processor cores, memory caches, and network interconnects. The tiles may communicate with each other by sending packets over the network.

Network congestion may occur in multi-tile systems when network traffic exceeds the capacity of network links or router buffers. The congestion may lead to increased latency and reduced throughput for inter-tile communication.

The present disclosure provides a multi-tile processing system that selects a packet distribution method based on network congestion in the multi-tile processing system. For example, the multi-tile processing system may determine network congestion along network paths between tiles. The multi-tile processing system may select between unicasting and path-based multi-casting based on the network congestion along network paths between tiles. In these and other embodiments, the network congestion along the network paths may be more than just network congestion surrounding a transmitter tile. Rather, the multi-tile processing system may consider the congestion along the entire network path between the transmitter and receiver tiles. Thus, congestion multiple tiles away from the transmitter tile may be considered when selecting a packet distribution method.

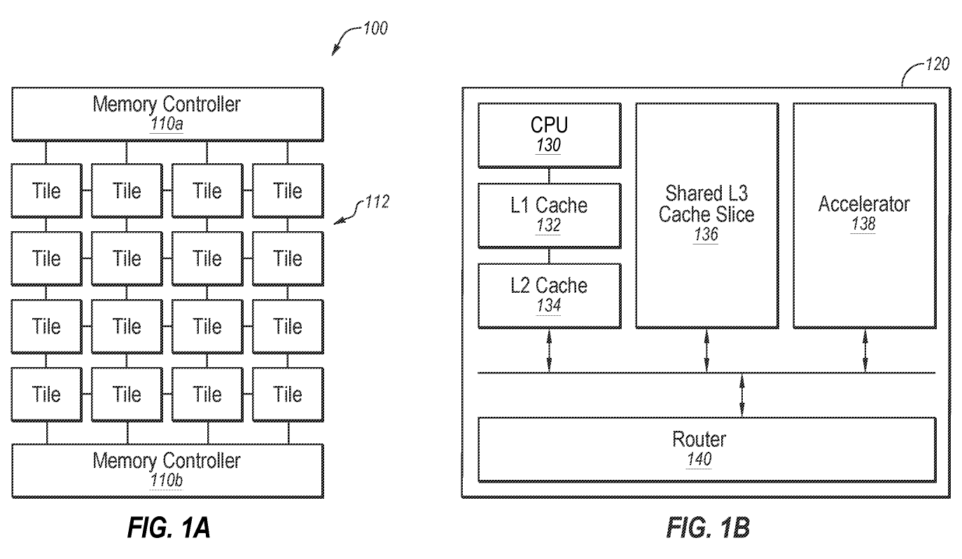

Embodiments of the present disclosure are explained with reference to the accompanying figures. FIG. 1A illustrates an example multi-tile processing system 100, according to one or more embodiments of the present disclosure. The multi-tile processing system 100 may include a first memory controller 110, a second memory controller 110b, and a tile array 112 of multiple tiles.

In some embodiments, the multi-tile processing system 100 is a computing architecture that utilizes the tile array 112 to execute workloads in parallel. The tile array 112 may include multiple tiles arranged in a grid or other configuration. Each tile may include one or more processor cores, memory caches, and network interconnects. For example, FIG. 1B illustrates elements of an example tile 120.

In some embodiments, the multi-tile processing system 100 executes workloads in parallel, with each tile handling a portion of the overall computation. During operation, tasks may be dynamically allocated to different tiles based on workload demands, optimizing resource utilization and/or power efficiency. In some embodiments, one or more of the tiles may include additional processing units, such as an accelerator or other processing core configured to execute domain-specific functions, such as artificial intelligence (AI) inference or graphics processing.

The first memory controller 110a and the second memory controller 110b may be coupled to the tile array 112 to provide the tile array 112 access to off-chip memory. The first and second memory controllers 110a and 110b may interface with external memory devices such as DRAM or other memory devices, to allow the tile array 112 to read and write data to the external memory.

The multi-tile processing system 100 may include a network interconnecting the tiles in the tile array 112. The network may enable communication between the tiles by allowing data packets to be sent between tiles. For example, each tile may include router circuitry to route packets between tiles and network links that link the tiles together. The tiles may send data packets between the tiles during processing of data or during other scenarios.

In some embodiments, network congestion may occur in the multi-tile processing system 100 when network traffic exceeds the capacity of network links or router buffers. For example, network congestion may occur when links between tiles experience packet traffic, queue lengths, data backups, and/or latency above a threshold amount. The threshold amount may be based on the operations being performed by the multi-tile processing system 100, the system requirements of the multi-tile processing system 100, among other factors.

In some embodiments, to address network congestion, the multi-tile processing system 100 may implement adaptive packet distribution methods based on the network congestion being experienced by the multi-tile processing system 100. In these and other embodiments, the adaptive packet distribution methods may include selecting between different packet distribution methods based on the network congestion. For example, the packet distribution method may be selected from a path-based multi-cast distribution method, a unicast distribution method, a combination of a path-based multi-cast distribution method and a unicast distribution method, among others.

In these and other embodiments, a unicast distribution method may include sending a packet from one source tile to one specific destination tile. A unicast distribution method may be a point-to-point communication. A multi-cast distribution method may include sending a packet from one source tile to a group of destination tiles but not to all tiles. A path-based multi-cast distribution method may include sending a packet from one source tile to a group of destination tiles but not to all tiles along a particular or predefined network path. The particular network path may be designed such that data reaches all the destination tiles in a manner without traversing all the tiles. Alternately or additionally, the particular network path may be designed such that data reaches all the destination tiles in a manner without traversing all the tiles and without traversing any tile more than once.

In some embodiments, the adaptive packet distribution methods may be selected based on network congestion of network paths between tiles that are communicating and not general network congestion of the multi-tile processing system 100. For example, network congestion may exist along links of tiles that form network paths between first and second tiles that are communicating but may not exist along a majority of links in the multi-tile processing system 100. In these and other embodiments, a first packet distribution method may be used for network paths between first and second tiles, but a second packet distribution method may be used for network paths between third and fourth tiles. As another example, a majority of links in the multi-tile processing system 100 may be experiencing network congestion, but a network path between first and second tiles may not be experiencing network congestion. In these and other embodiments, a first packet distribution method may be used for network paths between first and second tiles, but a second packet distribution method may be used for network paths between other tiles that are experiencing network congestion.

In some embodiments, a tile may determine network congestion for network paths between the tile and other tiles in the tile array 112. In these and other embodiments, the first tile may determine network congestion for a network path based on network congestion data received in packets that traverse the network path. The network congestion data received in a packet may indicate the network congestion along links along the path. In these and other embodiments, the network congestion data for the network path may include network congestion data for links that are not directly connected to the first tile. For example, the network path may include multiple intermediate tiles between the source tile and a destination tile. In these and other embodiments, the network congestion of the network path may be based on the network congestion for each link in the network path, including the links between the intermediate tiles and the destination tile that are not directly connected to the source tile.

In some embodiments, the network congestion data for a network path may be determined by each of the tiles along the network path. For example, a tile may be configured to determine network congestion data for outgoing links of the tile. As a packet traverses the tile, the network congestion data for the outgoing links of the tile may be added to the packet. For example, as a packet travels from a source tile to a destination tile, each intermediate tile may add congestion information about the outgoing links to the packet. In these and other embodiments, a tile may store the network congestion data received in incoming packets to allow the tile to maintain information about network congestion along various network paths in the system.

In some embodiments, the network congestion data received in a packet may relate to the network congestion data along a path that is opposite the path traveled by the packet. For example, the packet may traverse a path of tile A, to tile B, to tile C. In these and other embodiments, the network congestion data stored in the packet may include network congestion data for the network path of tile C, to tile B, to tile A. Thus, the network congestion data obtained by tile C from the packet may inform tile C about network congestion when tile C is sending a packet from tile C to tile A. In these and other embodiments, tile C may select a packet distribution method to send a packet to tile A based on the network congestion data.

In some embodiments, one or more memory caches in the tiles may be shared between the tiles, allowing data to be accessed by different tiles. For example, each of the tiles may include a memory cache slice. In these and other embodiments, a protocol for maintaining data consistency between the shared memory caches may be implemented by the multi-tile processing system 100. This protocol may involve transactions that include the tiles sending packets to other tiles to request or update data. Alternately or additionally, transactions may include tiles sending request packets, acknowledgement packets, and data packets to other tiles. In some embodiments, a tile may obtain network congestion data from a packet that is part of a first transaction of a protocol. In these and other embodiments, the tile may use the network congestion data to select a packet distribution method for sending a packet as part of a second transaction of the protocol.

Modifications, additions, or omissions may be made to the multi-tile processing system 100 without departing from the scope of the disclosure. For example, the tile array 112 may include more or fewer tiles than those tiles illustrated. Alternately or additionally, the tile array 112 may be arranged in a different configuration than that illustrated. Alternately or additionally, the multi-tile processing system 100 may include more or fewer memory controllers or the memory controllers may be positioned differently.

FIG. 1B illustrates an example tile 120, according to one or more embodiments of the present disclosure. The tile 120 may include a central processing unit 130, an L1 memory cache 132, an L2 memory cache 134, a shared L3 memory cache 136, an accelerator 138, and a router 140.

The central processing unit 130 of the tile 120 may include various components and subsystems to execute instructions and process data. For example, the central processing unit 130 may include one or more processor cores, each capable of executing multiple threads concurrently. The central processing unit 130 may interface with other components of the tile 120 such as the L1 memory cache 132, the L2 memory cache 134, the shared L3 memory cache 136, the accelerator 138, and the router 140 through appropriate interfaces and controllers.

The L1 memory cache 132 may be a dedicated cache memory located close to the central processing unit 130 within the tile 120. The L1 memory cache 132 may store frequently accessed data and instructions to reduce access times and improve overall system performance.

The L2 memory cache 134 may be a dedicated cache memory for the tile 120. The L2 memory cache 134 may be larger in capacity compared to the L1 cache and may serve as an intermediate storage between the L1 cache and main memory.

The shared L3 memory cache 136 may be a cache memory in the tile 120 that is shared among one or more tiles in a multi-tile processing system, such as the multi-tile processing system 100 of FIG. 1A. The shared L3 memory cache 136 may be accessible by various tiles for storing and retrieving data. In these and other embodiments, each tile may have access to the shared L3 memory cache 136 through a network that connects the tiles. The shared L3 memory cache 136 may serve as a larger, slower level of cache compared to the individual L1 and L2 caches that may be present within each tile.

Generally, each of the L1 memory cache 132, the L2 memory cache 134, the shared L3 memory cache 136 may be a non-transitory computer-readable storage media including Random Access Memory (RAM), Read-Only Memory (ROM), Electrically Erasable Programmable Read-Only Memory (EEPROM), or any other storage medium which may be used to store desired program code in the form of computer-executable instructions or data structures and which may be accessed by the central processing unit 130 and/or the accelerator 138. Combinations of the above may also be included within the scope of computer-readable storage media.

The accelerator 138 may include a specialized hardware component designed to perform specific computational tasks efficiently. For example, the accelerator 138 may be dedicated to a particular function, such as encryption, compression, or signal processing. In some embodiments, the accelerator 138 may be accessible by other tiles through the interconnect network. The accelerators 138 may operate in parallel with the central processing unit 130 in the tile 120, which may allow for offloading of computationally intensive tasks.

In some embodiments, the central processing unit 130 may interpret and/or execute program instructions and/or process data stored in the L1 memory cache 132, the L2 memory cache 134, the shared L3 memory cache 136. In some embodiments, the central processing unit 130 may fetch program instructions through the first memory controller 110a or the second memory controller 110b and load the program instructions into one or more of the L1 memory cache 132, the L2 memory cache 134, or the shared L3 memory cache 136.

In some embodiments, after program instructions are loaded into one or more of the L1 memory cache 132, the L2 memory cache 134, or the shared L3 memory cache 136, the central processing unit 130 may execute the program instructions, such as instructions to cause the central processing unit 130 to perform operations as described in this disclosure.

The router 140 may facilitate communication between tiles. The router 140 may include multiple input and output ports for receiving and transmitting packets to neighboring tiles. In some embodiments, the router 140 may include buffers to temporarily store packets as packets are routed between tiles. The router 140 may implement protocols for allowing data to be shared between the tile 120 and other tiles in a tile array. For example, the router 140 may implement a protocol for data consistency of the shared L3 cache slice.

In some embodiments, the router 140 may be configured to add network congestion data to packets as the packets pass through the tile 120. For example, the router 140 and/or the central processing unit 130 may determine network congestion for one or more links of the tile 120 and add network congestion data to a packet as the packet passes through the tile 120.

In some embodiments, the router 140 may support different packet distribution methods like unicast and multicast. In some embodiments, the router 140 may select a packet distribution method for sending packets based on network congestion data. Alternately or additionally, the central processing unit 130 may select a packet distribution method for sending packets based on network congestion data and provide instructions to the router 140 regarding how to route a particular packet.

Modifications, additions, or omissions may be made to the tile 120 without departing from the scope of the disclosure. For example, the tile 120 may not include the L2 memory cache 134. Alternately or additionally, the tile 120 may include another accelerator or other component.

As described with respect to FIG. 1A, the tiles of the tile array 112 may include a shared memory cache. In these and other embodiments, the multi-tile processing system 100 may implement a protocol for data consistency between the shared memory caches. For example, the protocol may manage the states of a memory block stored on a tile to ensure data consistency when multiple tiles are accessing the memory block.

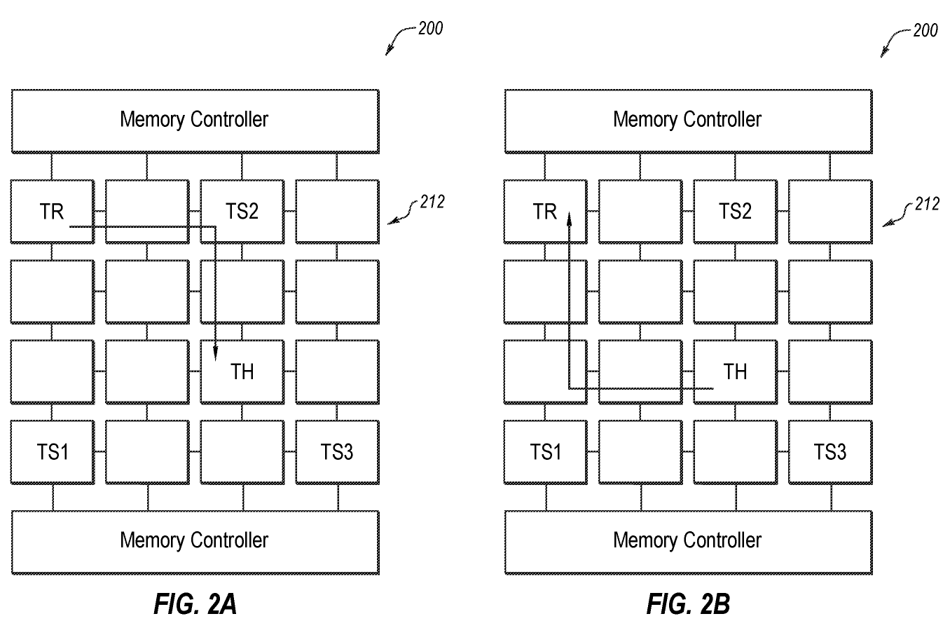

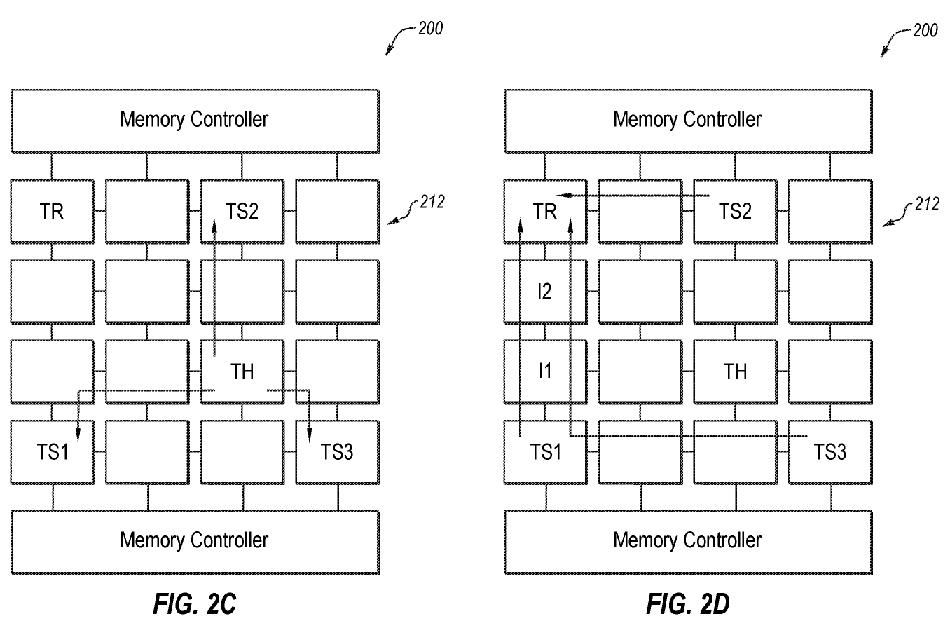

FIGS. 2A, 2B, 2C, and 2D illustrate various packet transfers that may occur as part of a first transaction of the protocol. The network congestion data may be collected during one or more of the packet transfers described with respect to FIGS. 2A, 2B, 2C, and 2D during a first transaction. The network congestion data may be used during a second transaction of the protocol to select a packet distribution method.

The transaction of the protocol illustrated in FIGS. 2A, 2B, 2C, and 2D may involve a tile requesting read and/or write access to a memory block stored on a shared cache of another tile. The other tile may be a home tile for the memory block such that the other tile is the tile that maintains the memory block when the memory block is accessed by a tile array after being provided to the tile array from memory controllers.

FIG. 2A illustrates transmission of a first packet on a first transaction in an example multi-tile processing system 200, according to one or more embodiments of the present disclosure. The multi-tile processing system 200 includes a tile array 212 that includes multiple tiles. The multi-tile processing system 200 and the tile array 212 may be analogous to the multi-tile processing system 100 and the tile array 112 of FIG. 1A.

As illustrated in FIG. 2A, the tile array 212 may include sixteen tiles. The first transaction may include a requesting tile TR requesting read and/or write access to a memory block that is maintained by the home tile TH. The other tiles identified in the tile array 212, TS1, TS2, and TS3 may be tiles that have previously accessed the memory block and have copies of the memory block stored thereon. As an example, the first transaction may be a Get Modified (GetM) request in a cache-coherence protocol.

In these and other embodiments, the tile TR may send a request to the tile TH for the most up-to-date version of the memory block. The request may include a first packet that identifies the memory block being requested by the tile TR. The first packet may traverse the tile array 212 along a network path that follows the arrow. As such, the network path may traverse across four intermediate tiles between the tile TR and the tile TH. In these and other embodiments, the tile TR may be a source tile, and the tile TH may be a destination tile.

In some embodiments, in response to obtaining the first packet, the tile TH may send a second packet to the tile TR with the memory block. The second packet may also include an identification of the other tiles in the tile array 212 that include a read-only copy of the memory block. The other tiles may include the tiles TS1, TS2, and TS3.

FIG. 2B illustrates transmission of the second packet in the tile array 212. The second packet may follow a different network path. In some embodiments, the transmission of the packets in the tile array 212 may follow dimension-based routing protocols. Dimension-based routing protocols may include X-Y routing or Y-X routing, among other protocols. In X-Y routing, packets may first be routed along the X-dimension until reaching the correct X-coordinate of the destination tile, then routed along the Y-dimension to reach the final destination. For example, the routing illustrated in FIG. 2A and 2B is X-Y routing. Y-X routing may operate similarly but in the reverse order, first routing along the Y-dimension and then the X-dimension. These dimension-ordered routing approaches may help prevent deadlock situations by ensuring packets make progress towards their destination without creating cyclic dependencies. Alternately or additionally, the second packet may follow the same network path as the first packet. In these and other embodiments, the routing protocol for the routing of the first packet and the second packet may be the same as illustrated in FIGS. 2A and 2B.

After transmitting the second packet, the tile TH also sends a third packet to each of the tiles TS1, TS2, and TS3 that include a read-only copy of the memory block. In these and other embodiments, the third packet may be an invalidation request. The invalidation request may indicate to the tiles TS1, TS2, and TS3 that the read-only copy of the memory block may be invalid as the memory block is being written to by the tile TR. The invalidation request may include an identification of the tile TR. In these and other embodiments, the third packet may be sent to multiple different tiles and potentially to every tile in the tile array 212 besides the tile TR and the tile TH based on the number of tiles that include a read-only copy of the memory block. As illustrated, only three tiles have a read-only copy of the memory block, but more or fewer tiles may include a read-only copy of the memory block.

To send the third packet, the tile TH may use network congestion data to determine how to send the third packet to the tiles TS1, TS2, and TS3. In these and other embodiments, the tile TH may have previously obtained the network congestion data for network paths between the tile TH and the tiles TS1, TS2, and TS3. Note that the network congestion data is not collected by the tile TH during the current transaction of the protocol being discussed. Rather, the network congestion data was collected previously for the network paths between the TH and the tiles TS1, TS2, and TS3.

The tile TH may select to unicast as the packet distribution method for the third packet to each of the tiles TS1, TS2, and TS3 as illustrated in FIG. 2C. In these and other embodiments, the arrows of FIG. 2C illustrates the network paths of the unicast distribution method for each of the third packets. In other scenarios, the tile TH may select a path-based multi-cast distribution method. In these and other embodiments, when the path-based multi-cast distribution method is selected, the dimension-based routing protocol selected for the path-based multi-cast distribution method may be different than the dimension-based routing protocol used to collect the network congestion data. For example, the dimension-based routing protocol used to collect the network congestion data may be X-Y routing and the dimension-based routing protocol for the multi-cast distribution method may be Y-X routing. By using a first dimension-based routing protocols for first packets that collect information on network congestion and a second dimension-based routing protocol for routing of second packets, the network paths followed by the first packets and the second packets may be the same.

In response to obtaining the third packets, the tiles TS1, TS2, and TS3 may be configured to generate and send a fourth packet to the tile TR. The fourth packet may be an acknowledgement packet that acknowledges that the tile TR has access to the memory block. In these and other embodiments, the tile TR may proceed to access the memory block after receiving the acknowledgement packet from each of the tiles TS1, TS2, and TS3.

Each of the tiles TS1, TS2, and TS3 may unicast a fourth packet to the tile TR. FIG. 2D illustrates transmission of the fourth packets to the tile TR. As the fourth packets are unicast to the tile TR, each tile that handles the fourth packet may provide network congestion data to the fourth packet. For example, the fourth packet from the tile TS1 to tile TR may be managed by two tiles, tile I1 and tile I2. The tiles I1 and I2 may each determine network congestion data and add the determined network congestion data to the fourth packet sent by the tile TS1. In these and other embodiments, the tile I1 may provide network congestion data regarding outbound traffic from the tile I1 to the tile TS1. The tile I2 may provide network congestion data regarding outbound traffic from the tile I2 to the tile I1. As a result, the fourth packet from the tile TS1 may include network congestion data for the network path from the tile TR to the tile TS1. In a similar manner, the fourth packet from the tile TS3 may include network congestion data for the network path from the tile TR to the tile TS3 and the fourth packet from the tile TS2 may include network congestion data for the network path from the tile TR to the tile TS2. I

In some embodiments, the tile TR may store the network congestion data from each of the fourth packets. The tile TR may use the network congestion data to select a network distribution method when sending packets in another transaction of the protocol, such as packets that include invalidation requests. Specifically, the tile TR may use the network congestion data from the fourth packets when sending invalidation request packets to the tiles TS1, TS2, and TS3.

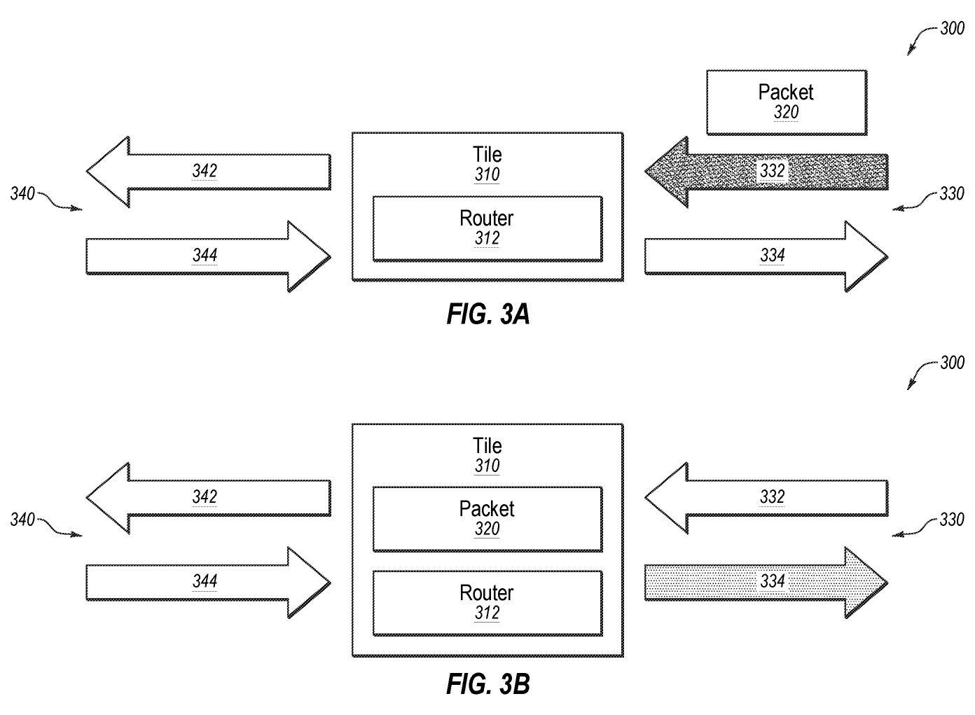

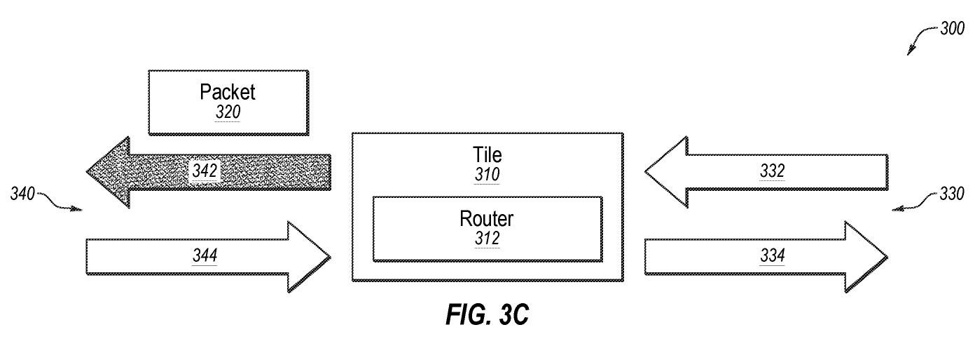

FIGS. 3A, 3B, and 3C illustrate handling of a packet 320 by an individual tile 310 as the packet 320 is traversing a network path, such as a network path in the tile array 212. For example, FIGS. 3A, 3B, and 3C may illustrate how the tile I1 may handle the fourth packet from the tile TS1 sent to tile TR.

In some embodiments, FIG. 3A illustrates reception of the packet 320 by the tile 310. The tile 310 includes a router 312. The tile 310 and the router 312 may be analogous to the tile 120 and the router 140 of FIG. 1B. In some embodiments, the tile 310 may include a first link 330 and second link 340.

A link may be a communication channel or connection between two tiles that may enable data transmission and exchange between the connected tiles. A link may be implemented as a physical connection, such as a wire or optical fiber, or as a logical connection established through software protocols. In some embodiments, a link, such as the first link 330, may be a bidirectional link that may enable data transmission in both directions between two connected tiles. The bidirectional link may allow each tile to both send and receive data through the same communication channel. In these and other embodiments, the first link 330 may include a first inbound portion 332 and a first outbound portion 334. The second link 340 may also be directional and may include a second inbound portion 344 and a second outbound portion 342. In some embodiments, the packet 320 may be received on the first inbound portion 332 of the first link 330.

FIG. 3B illustrates processing of the packet 320 by the tile 310, according to one or more embodiments of the present disclosure. The packet 320 may be processed by the router 312 to determine the tile to which the packet 320 may be sent.

In some embodiments, the network congestion of the other portion of the link that receives the packet 320 may be determined. The other portion of the link that receives the packet 320 may be the first outbound portion 334. The network congestion of the first outbound portion 334 may be determined based on the first outbound portion 334 being part of the first link 330 on which the packet 320 is received and being the opposite of the first inbound portion 332 on which the packet 320 is received.

In some embodiments, the tile 310 may determine the network congestion based on the data regarding an amount of traffic being sent over the first outbound portion 334. Alternately or additionally, the tile 310 may determine the network congestion based on space in an outbound buffer of the router 312 used for sending packets over the first outbound portion 334. Alternately or additionally, the tile 310 may determine the network congestion based on space in an inbound buffer of a router that receives packets over the first outbound portion 334.

In these and other embodiments, the space in an inbound buffer of a router that receives packets over the first outbound portion 334 may be shared with the tile 310 based on the network protocols used to couple the tile 310 to other tiles. For example, the network congestion of the first outbound portion 334 may be based on flow-control credits that the router 312 has for the first outbound portion 334. In these and other embodiments, flow-control credits may indicate how much available capacity exists to accept new data in a buffer of a router of a tile on the other side of the first outbound portion 334. The flow-control credit may be part of a credit-based flow control mechanism that may be used to manage data transfer between different tiles. For example, the router of the neighboring tile may send out a credit for each available space in the buffer of the router to the router 312.

In some embodiments, the router 312 may determine the first outbound portion 334 is congested based on the number of flow-control credits that the router 312 has for the first outbound portion 334. For example, the first outbound portion 334 may be determined to be congested based on the number of the flow-control credits satisfying a threshold. For example, when the number of flow-control credits is less than a 1/4, 1/3, 1/2, or some other amount of the total number of flow-control credits that may be issued by the neighboring tile, the router 312 may determine that the first outbound portion 334 is congested. The value for the threshold may be based on the algorithms being processed by a system that includes the tile 310, processing requirements for the system, among other factors.

In some embodiments, the threshold may be statically configured or dynamically adjusted based on network conditions. For example, the threshold may be increased or decreased in response to changes in network traffic, congestion levels, or available bandwidth. For example, the threshold may be lowered during periods of high network utilization to trigger more frequent use of packet distribution methods that use less network bandwidth. Conversely, the threshold may be raised when network conditions improve to allow more unicast transmissions. The dynamic adjustment may be performed periodically or in real-time based on monitored network metrics. Factors such as packet latency, queue depths, or link utilization percentages may be used to inform the threshold adjustments.

In some embodiments, the router 312 may include multiple outbound buffers. For example, the router 312 may include an outbound buffer for each of the different packet types, such as request packets and acknowledgement packets, being sent through the tile 310 in an interconnect network. For example, a first outbound buffer may be used for requests and a second outbound buffer may be used for acknowledgements. Based on the router 312 including a first buffer for a first packet type and a second buffer for a second packet type, each of the packet types may use a different dimension-based routing protocol. For example, a first packet type may use a first dimension-based routing protocol, such as a X-Y routing, and the second packet type may use a second dimension-based routing protocol, such as Y-X routing.

In these and other embodiments, the first dimension-based routing protocol may be associated with a first distribution method and the second dimension-based routing protocol may be associated with a second distribution method. In these and other embodiments, the packet 320 may be distributed using the first dimension-based routing protocol using a first distribution method and the network congestion of the first outbound portion 334 may be determined for packets following the second dimension-based routing protocol using the second distribution method. For example, the network congestion may be determined using the flow-control credit associated with a buffer of a router of a neighboring tile used for the second dimension-based routing protocol that is implemented for request packets such as invalidation requests.

In some embodiments, the router 312 may add the network congestion data regarding the congestion of the first outbound portion 334 to the packet 320. In these and other embodiments, the router 312 may add the network congestion data by flipping a bit in a bit mask that represents the links to indicate that the first outbound portion 334 of the first link 330 is congested. Alternately or additionally, the router 312 may add the network congestion data to the packet 320 by incrementing a network congestion counter in the packet 320. In response to the network congestion data indicating that there is congestion, the network congestion counter may be incremented by the tile 310. In response to the network congestion data indicating that there is no congestion, the network congestion counter may not be incremented by the tile 310. In these and other embodiments, the packet 320 may include a network congestion counter that may be set to zero when the packet 320 is first transmitted. The counter may be incremented once by each of the tiles that receive and pass along the packet 320 when a link, corresponding to the link on which the packet is received, is determined to be congested. The destination tile may receive the packet and determine a final count of the counter, which may indicate a total number of congested links on the network path.

In some embodiments, the destination tile may have information about a total number of links that the packet traverses in a network path and the count of the counter may indicate how many of the links are congested along the network path. In these and other embodiments, the destination tile may determine that a network path is congested based on a number of congested links in the network path. For example, a network path may be congested in response to the number of congested links in the network path satisfying a congestion threshold. For example, when the number of congested links in the network path is greater than 1/4, 1/3, 1/2, or some other amount of the total number of links in the network path, it may be determined that the network path is congested. The value for the threshold may be based on the algorithms being processed by a system that includes the tile 310, processing requirements for the system, among other factors.

In some embodiments, the threshold may be statically configured or dynamically adjusted based on network conditions. For example, the threshold may be increased or decreased in response to changes in network traffic, congestion levels, or available bandwidth. For example, the threshold may be lowered during periods of high network utilization to trigger more frequent use of packet distribution methods that use less network bandwidth. Conversely, the threshold may be raised when network conditions improve to allow more unicast transmissions. The dynamic adjustment may be performed periodically or in real-time based on monitored network metrics. Factors such as packet latency, queue depths, or link utilization percentages may be used to inform the threshold adjustments.

In some embodiments, after adding the network congestion data to the packet 320, the router 312 may send the packet over the second outbound portion 342. FIG. 3C illustrates transmission of the packet 320 by the tile 310 over the second outbound portion 342.

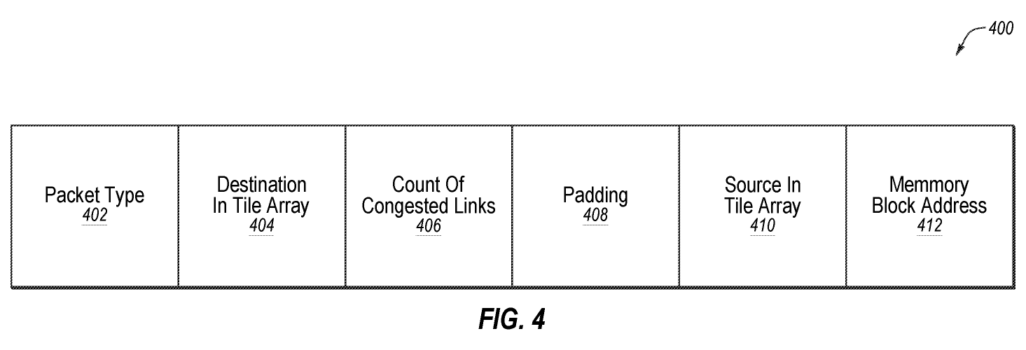

FIG. 4 illustrates an example packet 400, according to one or more embodiments of the present disclosure. The packet 400 may be an example of the packet 320 of FIGS. 3A, 3B, and 3C. The packet 400 may include a packet type field 402. The packet type field 402 may indicate the type or purpose of the packet, such as a request packet, response packet, or acknowledgement packet.

A destination field 404 may be included in the packet 400. The destination field 404 may specify the intended recipient tile of the packet within the multi-tile array. The destination field 404 may contain an identifier or address of the destination tile.

The packet 400 may also include a count of congested links field 406. The count of congested links field 406 may indicate the number of congested network links encountered along the network path of the packet. The count may be incremented by each tile that determines a congested link as the packet traverses the network path.

A padding field 408 may be included in the packet 400. The padding field 408 may contain filler data to adjust the overall packet size or align fields on certain byte boundaries.

The packet 400 may contain a source field 410 that specifies the originating tile of the packet within the multi-tile array. The source field 410 may include an identifier or address of the source tile that initially sent the packet.

A memory block address field 412 may be included in the packet 400. The memory block address field 412 may specify the address of a memory block or cache line that is relevant to the purpose of the packet such as for cache coherency operations between shared memory caches of different tiles.

Modifications, additions, or omissions may be made to the packet 400 without departing from the scope of the disclosure. For example, one or more fields may be added or removed from the packet 400.

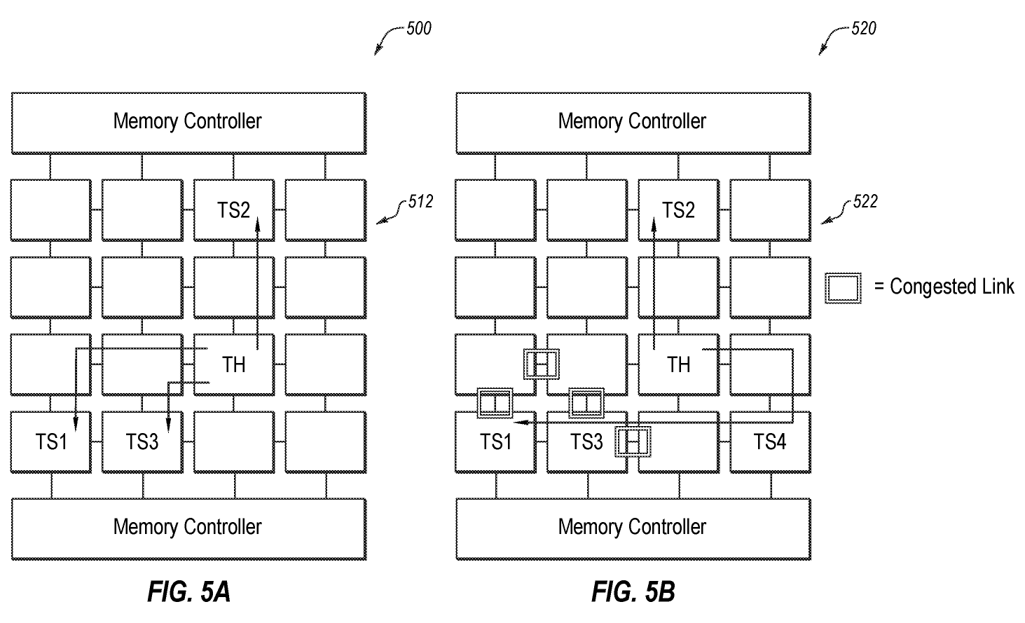

FIG. 5A and 5B illustrate various packet transfers that may occur as part of a transaction of the protocol in a multi-tile processing system. The transaction of the protocol may be sending packets to multiple different tiles from one tile. For example, the packets may be invalidation packets in a transaction of a cache-coherence protocol.

FIG. 5A illustrates transmission of multiple packets in an example multi-tile processing system 500, according to one or more embodiments of the present disclosure. The multi-tile processing system 500 includes a tile array 512 that includes multiple tiles. The multi-tile processing system 500 and the tile array 512 may be analogous to the multi-tile processing system 100 and the tile array 112 of FIG. 1A and the multi-tile processing system 200 and the tile array 212 of FIGS. 2A-2D.

As illustrated in FIG. 5A, the tile array 512 may include sixteen tiles. The first transaction may include a home tile TH. The other tiles identified in the tile array 512 include TS1, TS2, and TS3 tiles to which the TH tile may be sending a packet. The tile array 512 as illustrated does not include any congested links. As such, the TH tile has network congestion data that indicates no congestion in the tile array 512. As a result, the TH tile may select to unicast packets to each of the TS1, TS2, and TS3 tiles as illustrated in FIG. 5A.

FIG. 5B illustrates transmission of multiple packets in an example multi-tile processing system 520, according to one or more embodiments of the present disclosure. The multi-tile processing system 520 includes a tile array 522 that includes multiple tiles. The multi-tile processing system 520 and the tile array 522 may be analogous to the multi-tile processing system 100 and the tile array 112 of FIG. 1A, the multi-tile processing system 200 and the tile array 212 of FIGS. 2A-2D, and the multi-tile processing system 500 and the tile array 512 of FIG. 5A.

As illustrated in FIG. 5B, the tile array 522 as illustrated includes congested links. As a result, the TH tile has network congestion data that indicates network congestion in the tile array 522. In particular, the TH tile has network congestion data that indicates network congestion along unicast paths from the TH tile to the TS1 and TS3 tiles. The TH tile may select a packet distribution method for sending the packets to each of the TS1, TS2, and TS3 tiles based on the network congestion data. In these and other embodiments, the packets may be requests packet, such as invalidation request packets.

In some embodiments, the TH tile may select between a unicast distribution method and path-based multi-cast distribution method for each of the TS1, TS2, and TS3 tiles based on the network congestion data. In these and other embodiments, in response to the network congestion data indicating no congestion for a network path of one or more of the TS1, TS2, and TS3 tiles, a unicast distribution may be selected for one or more of the TS1, TS2, and TS3 tiles. In response to the network congestion data indicating congestion for network paths of one or more of the TS1, TS2, and TS3 tiles, the TH tile may determine if path-based multi-cast distribution method may be used. In these and other embodiments, the TH tile may determine how many of the TS1, TS2, and TS3 tiles with congestion are located in a path-based multi-cast path from the TH tile. In response to the number of the tiles satisfying a threshold, such as 2 or more, the TH tile may select a path-based multi-cast distribution method for the tiles with congestion in the path-based multi-cast path, such as the TS1 and TS3 tiles. For the tiles with congestion that are not part of the path-based multi-cast path, such as the TS2 tile, the TH tile may select a unicast distribution method.

Note that the distribution method selected by the TH tile may follow a same dimension-based routing protocol. Thus, both the unicast distribution method and the path-based multi-cast distribution method may use the same dimension-based routing protocol. The packets that provided the network congestion to the TH tile may have been transmitted using a different dimension-based routing protocol. In these and other embodiments, the packets may be acknowledgement packets. By using different dimension-based routing protocols, the packets that collect network congestion data and the packets routed based on the network congestion data may follow a same path.

In some embodiments, a tile that does not have congestion may be along the path-based multi-cast path selected for some of the tiles, such as the TS4 tile. In these and other embodiments, the TH tile may unicast to the TS4 tile or use the path-based multi-cast path to provide a packet to a TS4 tile.

In some embodiments, the TH tile may have a stored collection of path-based multi-cast paths. In these and other embodiments, the TH tile may obtain the stored path-based multi-cast paths and determine how many of the tiles are part of one of the stored path-based multi-cast paths. In response to the number of tiles satisfying a threshold, the TH tile may use the path-based multi-cast path. In response to the number of tiles not satisfying the threshold, the TH tile may use uni-cast paths for sending a packet to each of the tiles, even for those tiles with network congestion.

Alternately or additionally, the TH tile may determine if a path-based multi-cast path that includes a number of tiles with congestion that satisfy the threshold is feasible. In response to the path being feasible, the TH tile may use the path-based multi-cast path. In response to a path not being feasible, the TH tile may use uni-cast paths for sending a packet to each of the tiles, even those tiles with congestion.

In some embodiments, the TH tile may determine multiple path-based multi-cast paths that may be used. For example, if there are five tiles with network congestion and two tiles are part of a first path-based multi-cast path and three tiles are part of a second path-based multi-cast path, the TH tile may use both the first and second path-based multi-cast paths.

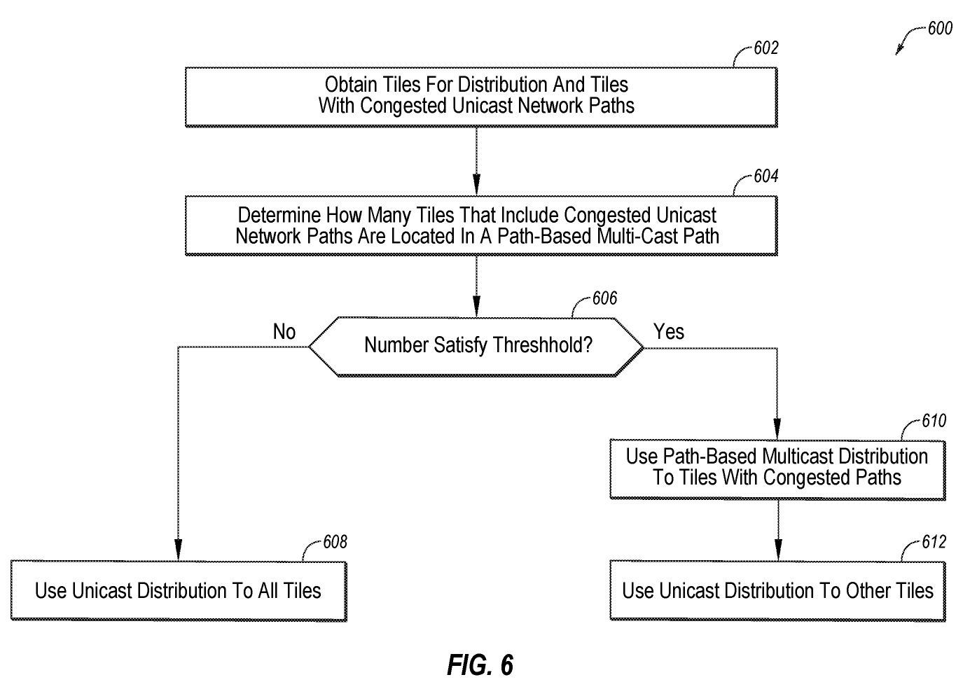

FIG. 6 is a flowchart of an example method 600 of packet distribution in a multi-tile processing system, according to one or more embodiments of the present disclosure. The method 600 may be performed by any suitable system, apparatus, or device. For example, the tile 120 of FIG. 1B or the tile 310 of FIGS. 3A, 3B, or 3C may perform one or more of the operations associated with the method 600. Although illustrated with discrete blocks, the steps and operations associated with one or more of the blocks of the method 600 may be divided into additional blocks, combined into fewer blocks, or eliminated, depending on the particular implementation.

The method 600 may be implemented as part of a protocol for maintaining data consistency between shared memory caches in a multi-tile processing system. In this context, the method 600 may be performed by a first tile that is selecting a packet distribution method to distribute a packet to multiple other tiles as part of a protocol, such as an invalidation request packet as part of a GetM transaction of a memory coherence protocol.

The method 600 may begin at block 602, where a first tile of a multi-tile processing system may obtain an indication of multiple tiles to which a packet may be sent for a protocol implemented by the multi-tile processing system. The first tile may also obtain an indication of network congestion of network paths between the first tile and the multiple tiles. In these and other embodiments, the network paths may be unicast paths between the first tile and the multiple tiles. The unicast paths may be paths between the first tile and the multiple tiles that are used by other packets in a protocol, such as acknowledgement packets. In these and other embodiments, the network congestion may include network congestion of network paths that are not directly adjacent the first tile.

At block 604, it may be determined how many of the multiple tiles that include congested unicast network paths are located in a path-based multi-cast path from the first tile. In some embodiments, the path-based multi-cast paths may be previously determined using various methods and techniques. For example, the path-based multi-cast paths may be determined during system initialization based on the network topology of the multi-tile processing system. Alternatively, the path-based multi-cast paths may be dynamically determined at runtime based on current network conditions and traffic patterns. In some implementations, the path-based multi-cast paths may be determined using graph traversal algorithms to identify efficient routes for distributing packets to multiple destinations. After being determined, the path-based multi-cast paths may be stored in routing tables or other data structures accessible to the tiles.

At block 606, it may be determined if the number of tiles with congested unicast paths that are also in the path-based multi-cast path satisfies a threshold. In response to the threshold being satisfied, the method may proceed to block 610. Otherwise, the method 600 may proceed to block 608.

In some embodiments, the threshold may be selected based on various factors. For example, a basis for selecting values for the threshold may include a total number of tiles in the multi-tile processing system, a typical congestion levels observed in the multi-tile processing system, a configuration of the tiles in the multi-tile processing system, and/or the relative performance characteristics of path-based multi-cast versus unicast distribution methods. The threshold may be set as a percentage of tiles with congested network paths, such as 20, 30, 40, 50, 60, or 70 percent or as an absolute number of tiles that include congested unicast network paths are located in a path-based multi-cast path, such as 2, 3, or 4. The specific threshold value may be tuned based on empirical testing to increase overall system performance and minimize latency. In some embodiments, the threshold may be dynamically adjusted based on real-time network conditions or workload characteristics.

At block 608, in response to the threshold not being satisfied, a unicast distribution method may be selected for all the multiple tiles regardless of network congestion along paths between the multiple tiles and the first tile.

At block 610, in response to the threshold being satisfied, a path-based multi-cast distribution method may be selected for the multiple tiles that are located in the path-based multi-cast path from the first tile and that have congested unicast network paths.

At block 612, a unicast distribution method may be selected for the other tiles of the multiple tiles that are not located in the path-based multi-cast path. In these and other embodiments, one or more of the other tiles may have congested unicast network paths.

Modifications, additions, or omissions may be made to the method 600 without departing from the scope of the disclosure. For example, the designations of different elements in the manner described is meant to help explain concepts described herein and is not limiting. For example, block 612 may be before block 610 or block 612 may be performed at the same time as block 610.

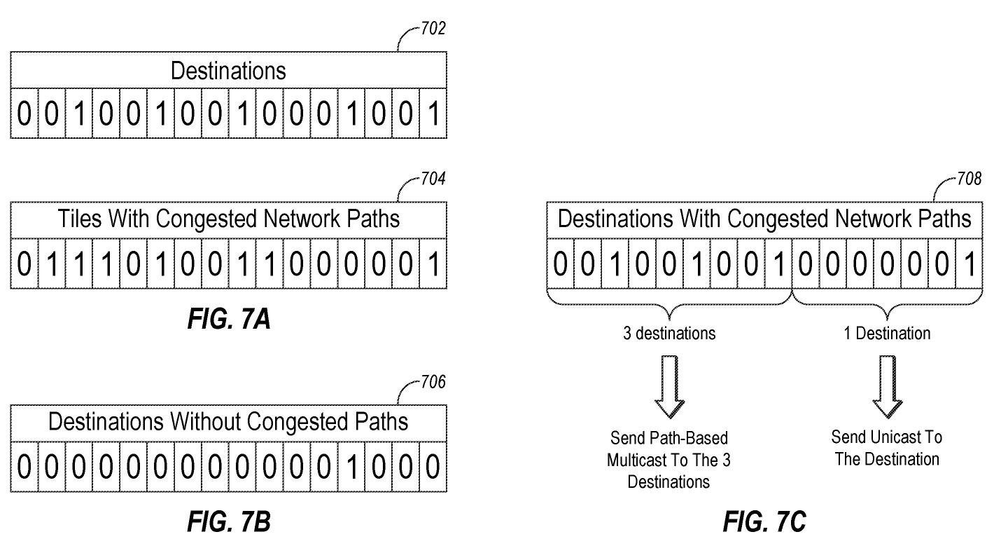

FIGS. 7A, 7B, and 7C illustrate bit masks that may be used to store information related to destination tiles, e.g., multiple tiles to which a packet may be sent, and bit masks that indicate network congestion of unicast network paths from a first tile. The bit masks may be a way to store information used by the tiles, methods, and systems discussed in this disclosure, and operations using the information regarding selecting a packet distribution method.

FIG. 7A illustrates example bit masks, according to one or more embodiments of the present disclosure. For example, FIG. 7A illustrates a first bit mask 702 that includes information related to destination tiles, e.g., multiple tiles to which a packet may be sent, from a first tile in a multi-tile processing system. FIG. 7A further illustrates a second bit mask 704 that includes information for network congestion of unicast network paths from the first tile.

A bit mask may be understood as a data structure used to store and manipulate binary information. In a bit mask, each bit may represent a specific condition or state, where a value of 1 may indicate that the condition is true or active, while a value of 0 may indicate that the condition is false or inactive. Information may be stored in a bit mask by setting or clearing individual bits to represent different states or properties. In the first bit mask 702, each bit may be associated with a different tile in the multi-tile processing system, and the first bit mask 702 may have as many bits as tiles. In these and other embodiments, a value of 1 may indicate that a packet is to be sent to the tile associated with the bit and a value of 0 may indicate that a packet is not to be sent to the tile associated with the bit. In the second bit mask 704, each bit may be associated with a different tile in the multi-tile processing system. In these and other embodiments, a value of 1 may indicate that a unicast path from the first tile to the tile associated with the bit is congested and a value of 0 may indicate that a unicast path from the first tile to the tile associated with the bit is not congested.

FIG. 7B illustrates a third bit mask 706, according to one or more embodiments of the present disclosure. The third bit mask 706 may be a combination of the first bit mask 702 and the second bit mask 704. The combination may be by a bit-wise A AND (NOT B) operation. The third bit mask 706 may illustrate a destination tile for which the network path from the first tile is not congested.

FIG. 7C illustrates a fourth bit mask 708, according to one or more embodiments of the present disclosure. The fourth bit mask 708 may be a combination of the first bit mask 702 and the second bit mask 704. The combination may be by a bitwise AND operation. The fourth bit mask 708 may illustrate destination tiles for which the network paths from the first tile are congested. In the fourth bit mask 708, the bit locations of zero to eight may be part of a first multi-cast path and the bit locations of nine to fifteen may be part of a second multi-cast path. As a result, a packet distribution method for the three destinations in the bit locations of zero to eight may be selected as a path-based multi-cast distribution method. Further, a packet distribution method for the one destination in the bit locations of nine to fifteen may be selected as a unicast distribution method.

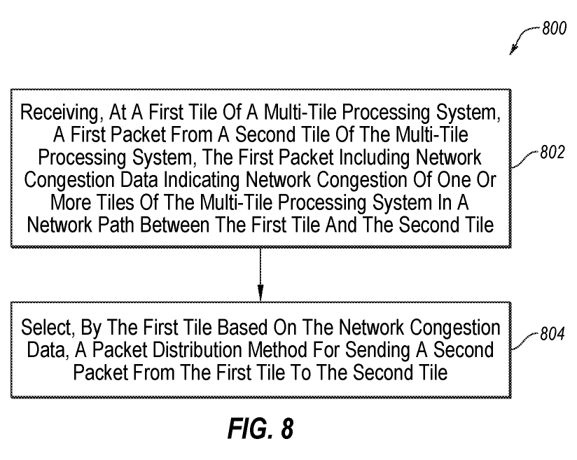

FIG. 8 is a flowchart of an example method 800 of packet distribution in a multi-tile processing system, according to one or more embodiments of the present disclosure. The method 800 may be performed by any suitable system, apparatus, or device. For example, the tile 120 of FIG. 1B, the tile 310 of FIGS. 3A, 3B, or 3C may perform one or more of the operations associated with the method 800. Although illustrated with discrete blocks, the steps and operations associated with one or more of the blocks of the method 800 may be divided into additional blocks, combined into fewer blocks, or eliminated, depending on the particular implementation.

The method 800 may begin at block 802, where a first tile of a multi-tile processing system may receive a first packet from a second tile of the multi-tile processing system. The first packet may include network congestion data indicating network congestion of one or more tiles of the multi-tile processing system in a network path between the first tile and the second tile.

At block 804, the first tile may select a packet distribution method for sending a second packet from the first tile to the second tile based on the network congestion data. In some embodiments, the packet distribution method may be selected from a path-based multi-cast distribution method, a unicast distribution method, or a combination of path-based multi-cast distribution and unicast distribution methods.

In some embodiments, memory caches of the tiles may be shared between the tiles. In these and other embodiments, the first packet may be received as part of a first transaction of a protocol for data consistency between the shared memory caches. The second packet may be sent as part of a second transaction of the protocol for data consistency between the shared memory caches. The first transaction of the protocol may be initiated by the first tile, while the second transaction of the protocol may be initiated by a third tile of the multi-tile processing system. In some cases, the first packet may be an acknowledgement packet of the protocol that further includes the network congestion data.

Modifications, additions, or omissions may be made to the method 800 without departing from the scope of the disclosure. For example, the designations of different elements in the manner described is meant to help explain concepts described herein and is not limiting. Further, the method 800 may include any number of other elements or may be implemented within other systems or contexts than those described.

For example, in some embodiments, each of the one or more tiles in the network path between the first tile and the second tile may add network congestion data to the first packet as the first packet passes through each of the one or more tiles in the network path from the second tile to the first tile. The network congestion data added by one of the one or more tiles in the network path may relate to congestion in a first direction of a network link of the one of the one or more tiles where the first packet is traversing a second direction of the network link. The network congestion data added by the one of the one or more tiles may be based on an available buffer space in another tile coupled to the network link satisfying a buffer space threshold.

In some embodiments, the selecting of the packet distribution method for sending the second packet may include obtaining an indication of a plurality of tiles, which include the second tile, to which a request is to be sent for a protocol implemented by the multi-tile processing system. The method 800 may then determine, based on network congestion data, which unicast network paths between the first tile and the plurality of tiles are congested. The packet distribution method may be selected based on which of the unicast network paths between the first tile and the plurality of tiles are congested.

In some embodiments, the method may determine how many of the plurality of tiles that include congested unicast network paths are located in a path-based multi-cast path. In response to the number satisfying a threshold, the method may select a path-based multi-cast distribution method for the two or more of the plurality of tiles that include congested unicast network paths. The method may also select a unicast distribution method for other of the plurality of tiles.

In some embodiments, the method 800 may be implemented by one or more non-transitory computer-readable media configured to store instructions that when executed by a processing system of the first tile perform the method 800.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, in the absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method of packet distribution in a multi-tile processing system, the method comprising:
receiving, at a first tile of a multi-tile processing system, a first packet from a second tile of the multi-tile processing system, the first packet including network congestion data indicating network congestion of one or more tiles of the multi-tile processing system in a network path between the first tile and the second tile; and
selecting, by the first tile based on the network congestion data, a packet distribution method for sending a second packet from the first tile to the second tile.

2. The method of claim 1, wherein the packet distribution method is selected from a path-based multi-cast distribution method, a unicast distribution method, or a combination of path-based multi-cast distribution and unicast distribution methods.

3. The method of claim 1, wherein memory caches of the tiles are shared between the tiles and the first packet is received as part of a first transaction of a protocol for data consistency between the shared memory caches and the second packet is sent as part of a second transaction of the protocol for data consistency between the shared memory caches.

4. The method of claim 3, wherein the first transaction of the protocol is initiated by the first tile and the second transaction of the protocol is initiated by a third tile of the multi-tile processing system.

5. The method of claim 3, wherein the first packet is an acknowledgement packet of the protocol that further includes the network congestion data.

6. The method of claim 1, further comprising:
adding, by each of the one or more tiles in the network path between the first tile and the second tile, the network congestion data to the first packet as the first packet passes through each of the one or more tiles in the network path from the second tile to the first tile.

7. The method of claim 6, wherein the network congestion data added by one of the one or more tiles in the network path relates to congestion in a first direction of a network link of the one of the one or more tiles where the first packet is traversing a second direction of the network link.

8. The method of claim 7, wherein the network congestion data added by the one of the one or more tiles is based on an available buffer space in another tile coupled to the network link satisfying a buffer space threshold.

9. The method of claim 1, wherein the selecting the packet distribution method for sending the second packet includes:
obtaining an indication of a plurality of tiles, which include the second tile, to which a request is to be sent for a protocol implemented by the multi-tile processing system; and
determining, based on network congestion data, which unicast network paths between the first tile and the plurality of tiles are congested, wherein the packet distribution method is selected based on which of the unicast network paths between the first tile and the plurality of tiles are congested.

10. The method of claim 9, further comprising:
determining how many of the plurality of tiles that include congested unicast network paths are located in a path-based multi-cast path;
in response to the number satisfying a threshold:
selecting a path-based multi-cast distribution method for the plurality of tiles that include congested unicast network paths located in the path-based multi-cast path; and
selecting a unicast distribution method for other of the plurality of tiles.

11. One or more non-transitory computer-readable medias configured to store instructions that when executed by a processing system of the first tile perform the method of claim 1.

12. A multi-tile processing system comprising:
a plurality of tiles that each include a memory cache that are shared between the tiles, a first tile of the plurality of tiles is configured to:
receive a first packet from a second tile of the plurality of tiles, the first packet including network congestion data indicating network congestion of the plurality of tiles in a network path between the first tile and the second tile; and
select, based on the network congestion data, a packet distribution method for sending a second packet from the first tile to the second tile.

13. The system of claim 12, wherein the packet distribution method is selected from a path-based multi-cast distribution method, a unicast distribution method, or a combination of path-based multi-cast distribution and unicast distribution methods.

14. The system of claim 12, wherein memory caches of the tiles are shared between the tiles and the first packet is received as part of a first transaction of a protocol for data consistency between the shared memory caches and the second packet is sent as part of a second transaction of the protocol for data consistency between the shared memory caches.

15. The system of claim 14, wherein the first transaction of the protocol is initiated by the first tile and the second transaction of the protocol is initiated by a third tile of the multi-tile processing system.

16. The system of claim 14, wherein the first packet is an acknowledgement packet of the protocol that further includes the network congestion data.

17. The system of claim 12, wherein the network congestion data is added to the first packet by one or more tiles of the plurality of tiles that are in a network path between the first tile and the second tile and the network congestion data relates to congestion in a first direction of a network link of the one or more tiles where the first packet is traversing a second direction of the network link.

18. The system of claim 17, wherein the network congestion data added by the one or more tiles is based on an available buffer space in another tile coupled to the network link satisfying a buffer space threshold.

19. The system of claim 12, wherein the selecting the packet distribution method for sending the second packet includes:
obtain an indication of a subset of tiles of the plurality of tiles, which include the second tile, to which a request is to be sent for a protocol implemented by the multi-tile processing system; and
determine, based on network congestion data, which unicast network paths between the first tile and the subset of tiles are congested, wherein the packet distribution method is selected based on which of the unicast network paths between the first tile and the subset of tiles are congested.

20. The system of claim 19, wherein the first tile is further configured to:
determine how many of the subset of tiles that include congested unicast network paths are located in a path-based multi-cast path;
in response to the number satisfying a threshold:
select a path-based multi-cast distribution method for the subset of tiles that include congested unicast network paths located in the path-based multi-cast path; and
select a unicast distribution method for other of the subset of tiles.
